(19) United States
(12) Patent Application Publication
(10) Pub. No.: US 2004/0266636 A1
(43) Pub. Date: Dec. 30, 2004

(54) Stripping composition and uses

(75) Inventor: Christian Galea, Siccieu St Julien et Carissieu (FR)

Correspondence Address: OLIFF & BERRIDGE, PLC, P.O. BOX 19928, ALEXANDRIA, VA, 22320, US

(73) Assignee: L'INDUSTRIELLE DE CHIMIE ELABOREE FRANCAISE (LICEF), VILLETTE D'ANTHON (FR)

(21) Appl. No.: 10/815,836

(22) Filed: Apr. 2, 2004

(30) Foreign Application Priority Data
Apr. 4, 2003 (FR) 03 04217

(51) Int. Cl. C11D 1/00

(52) U.S. Cl. 510/175

(57) ABSTRACT

The invention relates to a stripping composition comprising, as active ingredient, at least benzyl acetate and a solvent chosen from methoxypropyl acetate, diacetone alcohol, methyl ethyl ketone, isophorone and the mixture of these, and to the uses of such a composition.

The present invention relates to the chemical stripping of a support by removal of one or more coatings of various natures and thicknesses. The fields of application targeted by the invention are highly varied and although, in the present description, the invention is illustrated in particular in the construction and yachting sectors, the advantage of the invention is not limited to these fields, it being possible for the uses thereof to apply to industries of all types but also to the general public, for example for the stripping of wooden furniture and articles.

Mention may be made, to illustrate one of the fields of application of a stripping composition, of the document, EP-A-0 908 780, which discloses a process for the preparation of a crosslinked film which can be used as protective film, as mattness film or as insulating layer in electronic components, the said process comprising a stage of stripping the resin-coated substrate with a stripping composition. The latter comprises a stripping agent, optionally in combination with a solvent of high boiling point.

In the construction field and in particular in exterior faces, the coatings commonly encountered are organic in nature and are waterproofing paints of relatively great thickness, thick plastic coatings (TPC), decorative coatings of the trowelled marble type or thin films of acrylic or Pliolite®.

The most widely used stripping compositions for uncovering supports for the purpose of restoration or a new treatment are formulated from chlorinated solvents, which are effective but which are dangerous to use for the users and the environment. In addition to the disadvantages resulting directly from the chlorinated solvents, these very volatile compositions comprise a number of evaporation retarders, such as paraffins, which are difficult to remove, even by careful washing, whether with hot water or with cold water, and which can produce to a significant extent unsightly effects on the fresh coatings in the coating operation and in particular on acrylic or styrene/acrylic exterior waterproof coatings.

Attempts are being made to develop stripping compositions which are devoid of chlorinated solvents. Thus, according to Patent Application EP-A-1 138 727, a stripping composition for the construction industry is known which comprises at least one dibasic ester, a dipolar aprotic solvent, a cosolvent chosen from anisole and phenetole, a mixture of softening agents, a cellulose thickener, an inorganic filler and a dispersant. This composition exhibits the viscosity of a paste and it is applied as a thick layer to the support to be stripped, and then it is left to act.

The disadvantage of the substitution stripping compositions intended to replace the stripping compositions based on chlorinated solvents is their effectiveness, which is still inadequate and which can vary according to the nature of the coatings to be removed. Thus, in order to ensure that such a stripping composition is advantageous, it is advisable to define the nature of the coating, which is not an easy operation, for example when the exterior face to be stripped is old and covered with a sequence of layers of different coatings.

A stripping composition which is devoid of chlorinated solvents and which has a performance at least as good as that of chlorinated compositions still remains to be found, with the consequence that chlorinated compositions are still used on a large scale.

The Applicant Company has developed a stripping composition which meets these criteria. Surprisingly, the composition has proved to be effective on all the types of supports encountered in the construction field, in particular concrete or brick, but also on polymeric supports of polyester type such as those encountered in the yachting field, and on other supports, such as wood or metals, without risk of damage to the support treated and independently of the nature of the coating or coatings to be removed, which confers a virtually universal nature on it.

A first subject-matter of the invention is a stripping composition comprising, as active ingredient, at least benzyl acetate and a solvent chosen from methoxypropyl acetate, diacetone alcohol, methyl ethyl ketone, isophorone and the mixture of these.

The Applicant Company has observed, unexpectedly, that the combination of benzyl acetate with at least one of the above solvents constitutes the active ingredient of a composition which is effective on all supports and which does not result in any harmful diffusion into the support, whatever the coating, the need to determine the nature of the coating before use thus becoming obsolete.

In comparison with chlorinated stripping compositions, a composition of the invention does not require any rinsing, eliminating any risk of water damage observed during the stripping of exterior faces by chlorinated compositions.

A preferred composition of the invention is described below. It advantageously corresponds to at least any one of the characteristics set out below, optionally combined:

the proportion by weight of the benzyl acetate varies between 15 and 60% and that of the solvent varies between 4 and 25%, with respect to the total weight of the composition;

the composition comprises, as solvent, at least a mixture of diacetone alcohol and of methoxypropyl acetate; advantageously, this composition comprises 15 to 60% of benzyl acetate, 2 to 15% of diacetone alcohol and 2 to 15% of methoxypropyl acetate;

it is effective in the absence of any alkyl ester of hydroxyisobutyric acid and it is preferably devoid thereof;

the composition additionally comprises at least one diffusion agent chosen from dipolar aprotic solvents; these are chosen in particular from dimethyl sulphoxide (DMSO), N-methylpyrrolidone, dimethylformamide, acetonitrile, N-methylmorpholine, γ-butyrolactone, dimethylacetamide and their mixtures and/or their proportion by weight varies from 5 to 25%, with respect to the total weight of the composition;

the composition additionally comprises at least one activator chosen from diethanolamine, diethylenetriamine, dimethylethanolamine, quaternary amines and their mixtures; an advantageous proportion by weight of the activator varies from 0.5 to 4% with respect to the total weight of the composition;

the composition additionally comprises at least one plasticizer preferably chosen from dibasic esters, such as dialkyl esters and their mixtures; they are advantageously chosen from alkyl glutarates, alkyl succinates and alkyl adipates; a preferred plasticizer is a dimethyl esters or a mixture of dimethyl ester; its proportion by weight can vary from 8 to 25% with respect to the total weight of the composition;

the composition additionally comprises at least one inorganic filler preferably chosen from calcium phosphite, calcium carbonate, calcium hydroxide, clay, bentonite and talc, in a proportion by weight varying from 10 to 40% with respect to the total weight of the composition;

the composition additionally comprises at least one dispersant; the latter is chosen in particular from fatty alcohol glucosides, polyglucosides of glucose ester and sucrose ester type, alkylpolyglucoside ethers, fluorosurfactants derived from perfluoroalkylated polyamines, the acidic phosphoric ester of 2-ethylhexanol, and their mixtures, and its proportion by weight can vary from 0.5 to 4% with respect to the total weight of the composition;

the composition additionally comprises at least one thickener; a suitable thickener is a hydroxypropylmethylcellulose ester or a mixture of the latter, and a preferred proportion by weight varies from 0.2 to 3% with respect to the total weight of the composition;

the composition is devoid of water or substantially devoid of water in the sense that it preferably does not comprise more than 1% by weight thereof;

when it comprises at least one thickener and/or one inorganic filler, the proportions of these are appropriate for conferring thereon a viscosity such that it exists in the form of a gel or of a cream.

A composition of the invention can be applied with a roller, with a square brush or with a gun. Due to its texture, it can be left to act, preferably over a period varying from 5 minutes to two and a half hours, depending on the coating or coatings to be removed. Such a composition is highly advantageous as it exhibits a long open time which can extend over at least 24 hours. For very thick coatings, the open time can even reach 48 hours. It is thus possible to apply the composition to the support to be stripped, to leave to act and only to start removing the composition and the coating debris on the following day, without risk of the composition drying.

The composition and the debris from the coating or coatings in the form of shreds can be scraped off with a spatula and the support thus stripped bare is ready for a treatment.

Another subject-matter of the invention is the use of benzyl acetate as active ingredient for obtaining a stripping composition, in particular in combination with another solvent, for example an oxygen-comprising solvent.

Other subject-matters of the invention relate to favoured uses of a stripping composition of the invention, for obtaining a stripping composition intended for the construction field, or for obtaining a composition for the stripping of the lower part of the hulls of boats, for removing the antifouling coating.

The examples below illustrate compositions of the invention in a nonlimiting way.

### EXAMPLE 1

### Stripping Composition for the Construction Industry

The proportions shown below are expressed as percentage by weight with respect to the total weight of the composition:

| | |
|---|---|
| Benzyl acetate | 34 |
| Diacetone alcohol | 10 |
| DMSO | 18 |
| Methoxypropyl acetate | 6 |
| DBE ® | 10 |
| Diethanolamine | 0.5 |
| Glucopon ® 225 | 1.5 |
| Methocel ® | 1 |
| Calcium phosphite | 19 |

A composition of the invention as described above is prepared, preferably with stirring. It is easy to formulate by a competent person skilled in the art.

### EXAMPLE 2

### Stripping Composition for Yachting

The proportions shown below are expressed as percentage by weight with respect to the total weight of the composition:

| | |
|---|---|
| Benzyl acetate | 40 |
| Diacetone alcohol | 10 |
| Methoxypropyl acetate | 10 |
| DBE ® | 15 |
| Fluotan ® 830 | 1 |
| Benzalkonium chloride | 0.5 |
| Methocel ® | 1 |
| Calcium phosphite | 22.5 |

As emerges from this formulation, a stripping composition intended for the treatment of polyester boat hulls is advantageously devoid of dipolar aprotic solvent, to limit any risk of diffusion of the solvent to the core of the polymer.

In such an application, which does not run any risk of water damage, the support, namely the hull, is preferably rinsed with water after stripping.

1. Stripping composition comprising, as active ingredient, at least benzyl acetate and a solvent chosen from methoxypropyl acetate, diacetone alcohol, methyl ethyl ketone, isophorone and the mixture of these.

2. Composition according to claim 1, characterized in that the proportion by weight of the benzyl acetate varies between 15 and 60% and that of the solvent varies between 4 and 25%, with respect to the total weight of the composition.

3. Composition according to claim 2, characterized in that it comprises 15 to 60% of benzyl acetate, 2 to 15% of diacetone alcohol and 2 to 15% of methoxypropyl acetate.

4. Composition according to claim 1 characterized in that it additionally comprises at least one diffusion agent chosen from dipolar aprotic solvents.

5. Composition according to claim 4, characterized in that the dipolar aprotic solvents are chosen from dimethyl sulphoxide (DMSO), N-methylpyrrolidone, dimethylformamide, acetonitrile, N-methylmorpholine, y-butyrolactone, dimethylacetamide and their mixtures.

6. Composition according to claim 4, characterized in that the proportion by weight of the diffusion agent varies from 5 to 25% with respect to the total weight of the composition.

7. Composition according to claim 1 characterized in that it additionally comprises at least one activator chosen from diethanolamine, diethylenetriamine, dimethylethanolamine, quaternary amines and their

8. Composition according to claim 7, characterized in that the proportion by weight of the activator varies from 0.5 to 4% with respect to the total weight of the composition.

9. Composition according to claim 1 characterized in that it additionally comprises at least one plasticizer.

10. Composition according to claim 9, characterized in that the plasticizer is chosen from dibasic esters.

11. Composition according to claim 10, characterized in that the plasticizer is a dialkyl ester or a mixture of dialkyl esters chosen from alkyl glutarates, alkyl succinates and alkyl adipates.

12. Composition according to claim 11, characterized in that the plasticizer is a dimethyl ester or a mixture of dimethyl esters.

13. Composition according to claim 9, characterized in that the proportion by weight of the plasticizer varies from 8 to 25% with respect to the total weight of the composition.

14. Composition according to claim 1, characterized in that it additionally comprises at least one inorganic filler.

15. Composition according to claim 14, characterized in that the inorganic filler is chosen from calcium phosphite, calcium carbonate, calcium hydroxide, clay, bentonite and talc.

16. Composition according to claim 14, characterized in that the proportion by weight of the inorganic filler varies from 10 to 40% with respect to the total weight of the composition.

17. Composition according to claim 1, characterized in that it additionally comprises at least one dispersant.

18. Composition according to claim 17, characterized in that the dispersant is chosen from fatty alcohol glucosides, polyglucosides of glucose ester and sucrose ester type, alkylpolyglucoside ethers, fluorosurfactants derived from perfluoroalkylated polyamines, the acidic phosphoric ester of 2-ethylhexanol, and their mixtures.

19. Composition according to claim 18, characterized in that the proportion by weight of the dispersant varies from 0.5 to 4% with respect to the total weight of the composition.

20. Composition according to claim 1, characterized in that it additionally comprises at least one thickener.

21. Composition according to claim 20, characterized in that the thickener is a hydroxypropylmethylcellulose ester or a mixture of these.

22. Composition according to claim 20 characterized in that the proportion by weight of the dispersant varies from 0.2 to 3% with respect to the total weight of the composition.

23. Composition according to claim 1, characterized in that it is devoid of water.

24. Composition according to claim 1, characterized in that it is in the form of a gel or of a cream.

25. Use of benzyl acetate as active ingredient for obtaining a stripping composition.

26. Use of a stripping composition according to claim 1 for obtaining a stripping composition intended for the construction field.

27. Use of a stripping composition according to claim 1 for obtaining a composition for the stripping of the lower part of the hulls of boats.
